(19) United States
(12) Patent Application Publication
(10) Pub. No.: US 2012/0203404 A1
(43) Pub. Date: Aug. 9, 2012

(54) METHOD FOR HEATING HYBRID POWERTRAIN COMPONENTS

(75) Inventors: Andres V. Mituta, Auburn Hills, MI (US); Brian L. Spohn, Holly, MI (US); Karl Andrew Sime, Mason, MI (US)

(73) Assignee: GM GLOBAL TECHNOLOGY OPERATIONS LLC, Detroit, MI (US)

(21) Appl. No.: 13/020,857

(22) Filed: Feb. 4, 2011

(51) Int. Cl. B60W 20/00; B60W 10/08; B60W 10/06

(52) U.S. Cl. 701/22; 180/65.265; 903/930

(57) ABSTRACT

A method of controlling a hybrid powertrain having an electric machine and an engine is provided. The method includes determining a requested power and an excess power for the hybrid powertrain. The requested power substantially meets the needs of the hybrid powertrain. The excess power is non-zero and is not included in the determined requested power. The method also includes absorbing the excess power with the electric machine.

### STATEMENT REGARDING FEDERALLY SPONSORED RESEARCH OR DEVELOPMENT

This invention was made with U.S. Government support under an Agreement/Project number: vss018, DE-FC26-08NT04386, A000, awarded by the Department of Energy. The U.S. Government may have certain rights in this invention.

### TECHNICAL FIELD

This disclosure relates to operation and control of components within hybrid and alternative energy powertrains.

### BACKGROUND

Motorized vehicles include a powertrain operable to propel the vehicle and power the onboard vehicle electronics. The powertrain, or drivetrain, generally includes an engine that powers the final drive system through a multi-speed power transmission. Many vehicles are powered by a reciprocating-piston type internal combustion engine (ICE).

Hybrid vehicles utilize multiple, alternative power sources to propel the vehicle, minimizing reliance on the engine for power. A hybrid electric vehicle (HEV), for example, incorporates both electric energy and chemical energy, and converts the same into mechanical power to propel the vehicle and power the vehicle systems. The HEV generally employs one or more electric machines (motor/generators) that operate individually or in concert with the internal combustion engine to propel the vehicle. Electric vehicles also include one or more electric machines and energy storage devices used to propel the vehicle.

The electric machines convert kinetic energy into electric energy which may be stored in an energy storage device. The electric energy from the energy storage device may then be converted back into kinetic energy for propulsion of the vehicle, or may be used to power electronics and auxiliary devices or components.

### SUMMARY

A method of controlling a hybrid powertrain is provided. The hybrid powertrain includes an electric machine and an engine, and the method includes determining a requested power for the hybrid powertrain and determining an excess power for the hybrid powertrain.

The requested power substantially meets the needs of the hybrid powertrain. The excess power is non-zero and is not included in the determined requested power. The method includes absorbing the excess power with the electric machine.

The method may include determining an ideal control current and an energy-dissipating control current for the electric machine. The ideal control current absorbs the excess power with the electric machine at substantially optimal efficiency. The energy-dissipating control current, however, causes the electric machine to intentionally convert a portion of the excess power into heat energy. The method also includes controlling the electric machine with the energy-dissipating control current, such that the electric machine produces heat energy from the excess power. The heat energy warms the electric machine.

The above features and advantages, and other features and advantages, of the present invention are readily apparent from the following detailed description of some of the best modes and other embodiments for carrying out the invention, as defined in the appended claims, when taken in connection with the accompanying drawings.

### BRIEF DESCRIPTION OF THE DRAWINGS

FIG. 1 is a schematic diagram of a hybrid powertrain;

FIG. 2A is a schematic graph of a three-phase current for controlling an electric machine of the hybrid powertrain shown in FIG. 1;

FIG. 2B is a schematic graph of one phase of a three-phase current for controlling the electric machine, shown with a flux-neutral current juxtaposed against a motoring current and a generating current;

FIG. 3A is a schematic graph of a single phase of the three-phase control current for the first electric machine, showing an ideal phase and an amplitude shifted phase configured to heat the first electric machine;

FIG. 3B is a schematic graph of a single phase of the three-phase control current for the first electric machine, showing an ideal phase, phase-angle shift, and a phase-angle shift combined with an amplitude shift;

FIG. 4A is a schematic graph of a single phase of the three-phase machine control current for the first electric machine, showing a pulse-width modulated (PWM) wave forming the AC machine control current, including showing both standard portions of and shape-shifted portions of the PWM wave;

FIG. 4B is a schematic graph of the resultant effects on a DC-bus and a battery of the powertrain shown in FIG. 1, when subjected to a control current similar to that shown in FIG. 4A, showing a rapid charge pulse interspersed in a discharge event, the frequency of which is configured to heat the battery;

FIG. 4C is a schematic graph of similar resultant effects on the DC-bus and the battery to those shown in FIG. 4B, but showing a rapid discharge pulse interspersed in a charge event;

FIG. 5 shows a schematic flow chart diagram of the high level of an algorithm or method for controlling a hybrid powertrain, such as the powertrain shown in FIG. 1;

FIG. 6 shows a sub-routine of the method shown in FIG. 5, which is configured to heat the first electric machine;

FIG. 7 shows another sub-routine of the method shown in FIG. 5, which is configured to heat the battery; and

FIG. 8 shows a schematic power-flow diagram of intentional conversion of an excess power into multiple energy forms by the electric machine of the hybrid powertrain shown in FIG. 1.

### DETAILED DESCRIPTION

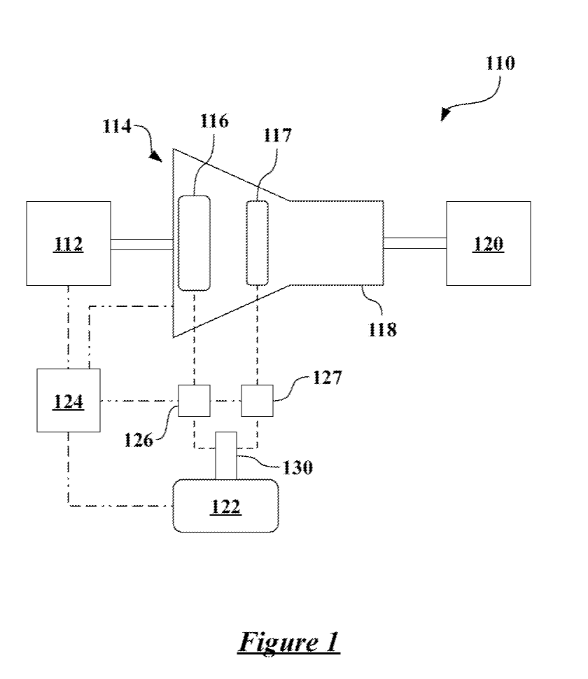

Referring to the drawings, wherein like reference numbers correspond to like or similar components whenever possible throughout the several figures, there is shown in FIG. 1 a schematic diagram of a hybrid powertrain 110, which may generally be referred to as a hybrid powertrain or an alternative-fuel powertrain. The hybrid powertrain 110 includes an internal combustion engine 112 and a transmission 114 of a vehicle (not shown).

The engine 112 is drivingly connected to the transmission 114, which is a hybrid transmission having one or more first electric machine 116 and the second electric machine 117 incorporated therewith. The first electric machine 116 and the second electric machine 117 may be disposed within a housing 118 or may be disposed outside of the transmission 114. For example, and without limitation, one or more electric machines, such as a first electric machine 116 and a second electric machine 117, may be disposed between the engine 112 and the transmission 114, or may be disposed adjacent the engine 112 and connected by a belt or chain to the engine 112.

While the present invention is described in detail with respect to automotive applications, those skilled in the art will recognize the broader applicability of the invention. Those having ordinary skill in the art will recognize that terms such as “above,” “below,” “upward,” “downward,” et cetera, are used descriptively of the figures, and do not represent limitations on the scope of the invention, as defined by the appended claims.

The transmission 114 is operatively connected to a final drive 120 (or driveline). The final drive 120 may include a front or rear differential, or other torque-transmitting mechanism, which provides torque output to one or more wheels through respective vehicular axles or half-shafts (not shown). The wheels may be either front or rear wheels of the vehicle on which they are employed, or they may be a drive gear of a track vehicle. Those having ordinary skill in the art will recognize that the final drive 120 may include any known configuration, including front-wheel drive (FWD), rear-wheel drive (RWD), four-wheel drive (4WD), or all-wheel drive (AWD), without altering the scope of the claimed invention.

In addition to the engine 112, the first electric machine 116 and the second electric machine 117 act as traction devices or prime movers for the hybrid powertrain 110. The first electric machine 116 and the second electric machine 117 (which may as be referred as motors or motor/generators) are capable of converting kinetic energy into electric energy and of converting electric energy into kinetic energy. A battery 122 acts as an energy storage device for the hybrid powertrain 110 and may be a chemical battery, battery pack, or another energy storage device (ESD).

Depending upon the configuration of the hybrid powertrain 110 and the transmission 114, the first electric machine 116 and the second electric machine 117 may be similarly-sized or differently-sized motor/generators. For illustrative purposes, much of the description will reference only the first electric machine 116. However, either or both of the first electric machine 116 and the second electric machine 117 may be utilized with the methods described herein.

The first electric machine 116 is in communication with the battery 122. When the first electric machine 116 is converting electric energy into kinetic energy, current flows from the battery 122 to the first electric machine 116, such that the battery 122 is discharging stored energy. This may be referred to as motoring, or as a motor mode. Conversely, when the first electric machine 116 is converting kinetic energy into electric energy, current flows into the battery 122 from the first electric machine 116, such that the battery 122 is being charged and is storing energy. This may be referred to as generating, or as a generator mode. Note, however, that internal losses of the first electric machine 116, the battery 122, and the wiring of the hybrid powertrain 110 may alter the actual current flow between the battery 122 and the first electric machine 116.

FIG. 1 shows a highly-schematic controller or control system 124. The control system 124 may include one or more components (not separately shown) with a storage medium and a suitable amount of programmable memory, which are capable of storing and executing one or more algorithms or methods to effect control of the hybrid powertrain 110. Each component of the control system 124 may include distributed controller architecture, such as a microprocessor-based electronic control unit (ECU). Additional modules or processors may be present within the control system 124. The control system 124 may alternatively be referred to as a Hybrid Control Processor (HCP).

The battery 122 is high voltage direct current coupled (DC-coupled) to a first power inverter module (PIM), which may be referred to a first PIM 126. A second PIM 127 may be in communication with the second electric machine 117. Alternatively, the first PIM 126 may be configured to communicate with, and control, both the first electric machine 116 and the second electric machine 117. The battery 122 is in communication with the first PIM 126 and the second PIM 127 via DC lines, transfer conductors, or a DC-bus 130.

The first PIM 126 communicates with the control system 124 and with the first electric machine 116. Electrical current is transferable to or from the battery 122 in accordance with whether the battery 122 is being charged or discharged. The first PIM 126 includes power inverters and respective motor controllers configured to receive motor control commands and control inverter states therefrom for providing motor drive or motor regeneration functionality.

In response to control signals from the control system 124, the first PIM 126 communicates a machine control current to the first electric machine 116. The first PIM 126 converts between the direct current of the battery 122 and an alternating current (AC) to the first electric machine 116. As described herein, the AC machine control current is actually formed from pulsed DC current. In regeneration control, the first PIM 126 receives AC current from the first electric machine 116 and provides DC current to the battery 122. The net DC current provided to or from the first PIM 126 (and also, in some cases, the second PIM 127) determines the charge or discharge operating mode of the battery 122. The first electric machine 116 and the second electric machine 117 may be, for example and without limitation, three-phase AC machines and the first PIM 126 and the second PIM 127 may be complementary three-phase power electronics.

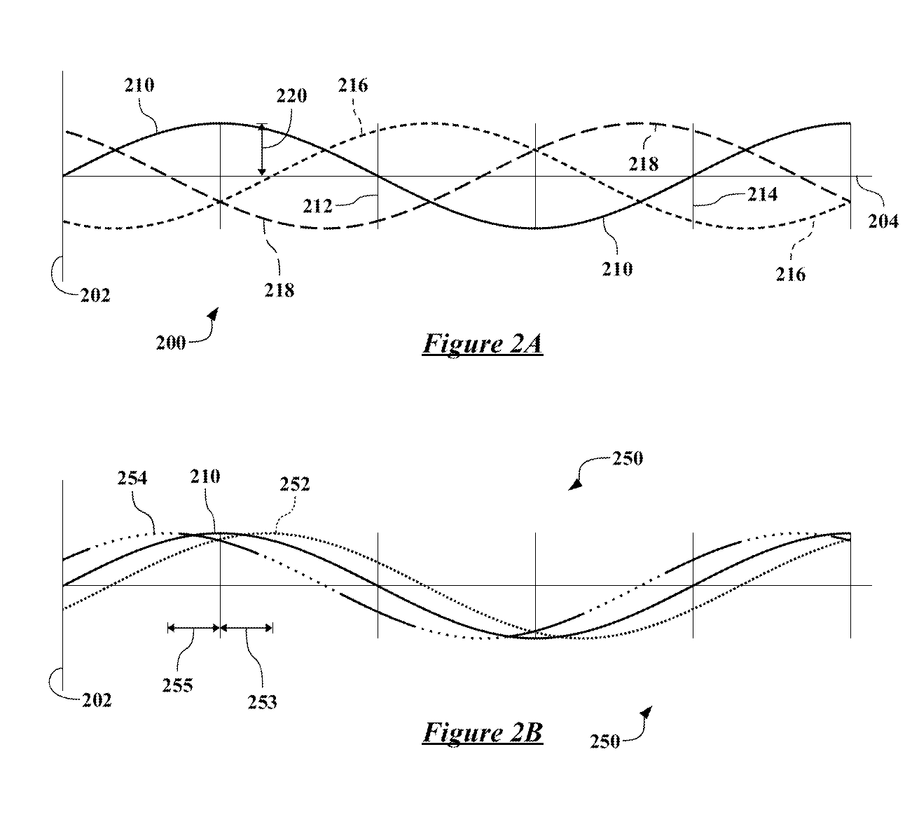

Referring now to FIG. 2A and FIG. 2B, and with continued reference to FIG. 1, there are shown a schematic graph 200 of a three-phase current for controlling the first electric machine 116 of the hybrid powertrain 110 and a schematic graph 250 showing the control current shifted to cause generating and motoring flux differentials. The graph 200 of FIG. 2A may show the three-phase current operating at an ideal generation state, and ideal motoring state, or a neutral state, in which the first electric machine 116 is neither motoring nor generating.

A y-axis 202 is schematically illustrative of the three-phase current (and voltage, because current and voltage are proportional) and moves from positive to negative as the AC current oscillates. The value of current along the y-axis 202 may vary greatly based upon the hybrid powertrain 110, the first electric machine 116, and the battery 122. An x-axis 204 is schematically illustrative of time.

In the three-phase current shown, a first phase 210 may be referred to as an A-phase or a U-phase. In FIGS. 2A and 2B, for illustrative purposes, half-wavelengths of the first phase 210 are marked along the y-axis 202. A half-wave mark 212 denotes the return of the first phase 210 to zero current after being positive. The half-wave mark 212 represents 180 degrees or Pi radians of rotation. A full-wave mark 214 denotes the return of the first phase 210 to zero current after being negative. The full-wave mark 214 represents three hundred sixty degrees or 2Pi radians of rotation. Unnumbered quarter-wave marks are shown between the half-wave mark 212 and the full-wave mark 214.

A second phase 216 may be referred to as a B-phase or a V-phase, and is offset from the first phase 210 by one hundred twenty degrees. A third phase 218 may be referred to as a C-phase or a W-phase, and is offset from the first phase 210 by two hundred forty degrees. Therefore, the three phases are each electrically offset by one hundred twenty degrees, and the three-phase current may be considered as symmetrical. Each of the three phases corresponds to one or more winding sets on either a stator (not shown) or a rotor (not shown) of the first electric machine 116. Combined, the three phases make up a machine control current for the first electric machine 116.

For illustrative purposes, this description will assume the rotor of the first electric machine 116 is moving and the stator is fixed to the transmission 114. Furthermore, for illustrative purposes, this description will assume the rotor is a permanent magnet (PM) rotor; although other motor designs—such as permanent magnet stator or induction motor—may be utilized. The configuration of the first electric machine 116 illustrated herein may also be referred to as an interior permanent magnet (IPM) motor.

Where the first electric machine 116 is a PM rotor machine, the rotation of the rotor determines the frequency of the first, second, and third phases 210, 216, and 218, which are all substantially equal. Control over the first electric machine 116 occurs through control of the magnitude and spatial location of the stator current (shown in FIGS. 2A and 2B) with respect to the rotor position. When an AC voltage (resulting from the AC control current) is applied by the first PIM 126 across the stator windings of the first electric machine 116, current flows through the stator windings and produces a magnetic flux, which is a rotating magnetic flux. This rotating flux will rotate at a synchronous speed, which will depend upon the number of poles and the frequency of current supply given to the first electric machine 116.

The first PIM 126 drives the voltage and current of each winding in the stator to cause a rotating electromagnetic field or rotating flux around the stator, which causes the rotor to rotate relative to the stator. The rotating magnetic field either chases or leads a fixed magnetic field, depending upon whether the first electric machine 116 is generating or motoring, produced by the rotor. Specifically, the windings are sequentially energized to produce a rotating current path through two of the windings, leaving the third winding in tristate. The fixed magnetic field may be generated by permanent magnets, as in a permanent magnet motor, which is generally described herein; or by an electric field, as in an induction motor.

An amplitude 220 shows the peak current amplitude of each of the phases. Alternatively, the current may be measured by effective amplitude of the current or voltage. As shown in FIG. 2A, as with many three-phase devices, each phase has substantially the same amplitude.

As described herein, to control the power of first electric machine 116, the first PIM 126 (as directed by the control system 124) uses pulse width modulation (PWM) to substantially emulate each phase of the control current. PWM is a nonlinear supply of power, during which the power being supplied is switched on and off according to a pattern. By modifying the percentage of “on” time supplied, the first PIM 126 can control the speed of rotation of the first electric machine 116. The speed of rotation is controlled by the pulse frequency and the torque by the pulse current.

Because the first electric machine 116 is both a motor and a generator, it may have an imparted speed of rotation and an imparted flux due to the components (such as the engine 112 or the final drive 120) attached thereto. Even while the first electric machine 116 is in a neutral state (neither generating nor motoring) the engine 112 may be rotating and causing the rotor of the first electric machine 116 to move relative to the stator. Therefore, the imparted speed may be considered as the baseline, such that the change in speed of rotation of the first electric machine 116 is controlled by the change in pulse frequency and the change in torque by the change in pulse current (both relative to the neutral operating state of the first electric machine 116).

FIG. 2B again shows the first phase 210, but does not show the other two phases, which are substantially similar but offset. Therefore, a single phase may be shown to represent all three phases of the machine control current for the first electric machine 116. The first phase 210 shown in FIG. 2B is at a neutral state, and may, therefore, also represent the flux position of the rotor. A motoring control phase 252 shows the relative machine control current used for placing the first electric machine 116 into motoring mode, in which the first electric machine 116 contributes mechanical power to the hybrid powertrain 110. The motoring control phase 252 is shifted by a motoring phase angle 253.

By shifting stator flux to the motoring phase angle 253, the flux of the stator leads the rotor. The motoring control phase 252 pulls the rotor forward (in its direction of rotation) and adds torque to the rotor. The added torque is motoring torque for the hybrid powertrain 110, and is derived from electrical energy (usually stored in the battery 122).

A generating control phase 254 shows the relative machine control current used for placing the first electric machine 116 into generating mode, in which the first electric machine 116 removes or absorbs mechanical power from the hybrid powertrain 110. The generating control phase 254 is shifted by a generating phase angle 255. Due to shifting the stator flux by the generating phase angle 255, the flux of the stator lags or trails the rotor. The generating control phase 254 pulls the rotor backward (relative to the direction of rotation) and removes torque to the rotor. The removed torque is generating torque for the hybrid powertrain 110, and may be stored in the battery 122.

When the first electric machine 116 is neither generating nor motoring—as shown on the first phase line 210—there is a net-zero flux differential between the rotating rotor and the rotating electro-magnetic field of the stator. However, when the first electric machine 116 is generating, the flux of the stator trails the flux of the rotor and there is a flux differential between the two. If the battery 122 is able to accept current flow, the flux differential causes current to flow from the first PIM 126 into the battery 122, increasing the state of charge thereof.

Phase-shifting the control current for the first electric machine 116 to either the motoring control phase 252 or the generating control phase 254 may also be illustrated rotationally with respect to the rotor. The true north position (at twelve-o-clock) may be used to represent the neutral position of the permanent flux field from the rotor. Shifting from the first phase 210 to the motoring control phase 252 rotates the stator flux clockwise by the motoring phase angle 253. This rotation in the stator flux creates a flux differential between the rotor and the stator which will cause the first electric machine 116 to move into motoring mode.

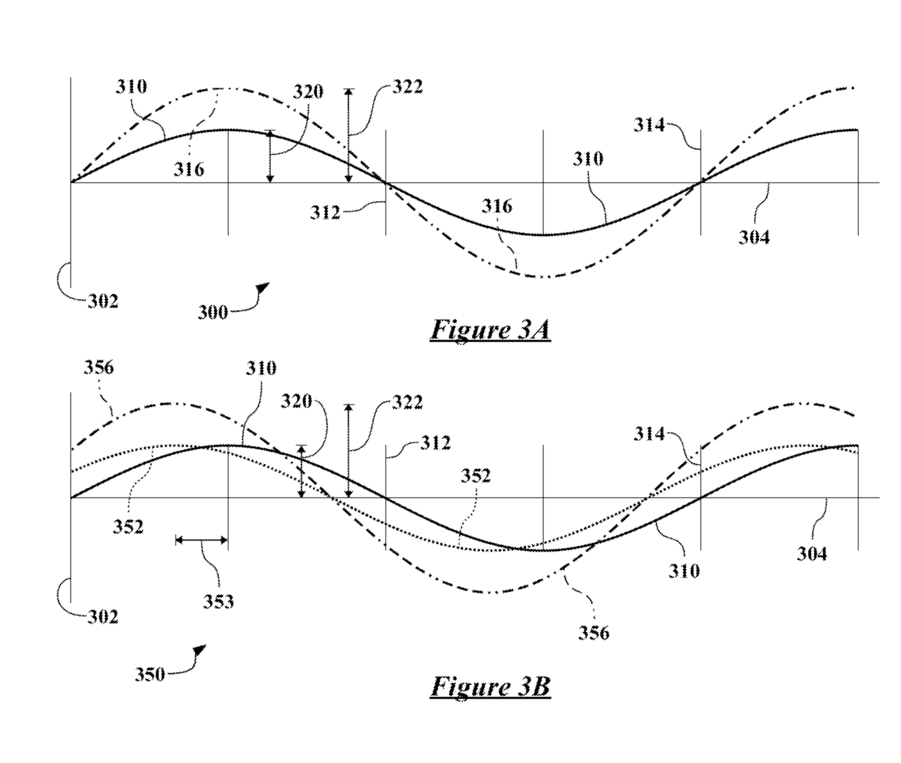

Referring now to FIG. 3A and FIG. 3B, and with continued reference to FIGS. 1, 2A, and 2B, there is shown a schematic graph 300 and a schematic graph 350 of a single phase of a three-phase machine control current for the first electric machine 116. FIG. 3A shows an amplitude shift, which is a relative increase in current flow configured to heat the first electric machine 116 and the transmission 114. FIG. 3B shows a phase-angle shift, which is a relative shift in the phase angle of the machine control current and the stator flux away from ideal, and is also configured to heat the first electric machine 116 and the transmission 114. FIG. 3B also shows the combination of amplitude shift and phase-angle shift.

The graph 300 and the graph 350 both show a ideal phase 310 operating at an ideal generation state, in which the first electric machine 116 is converting kinetic energy into electrical energy at peak or optimal efficiency for a given set of operating conditions. Optimal efficiency, as used herein, refers to conversion between electrical and mechanical energy at the highest efficiency available to the first electrical machine 116 under the specific operating conditions. Similar to the graph 200 shown FIG. 2A, in FIGS. 3A and 3B a y-axis 302 is schematically illustrative of current (or voltage) moves from positive to negative as the AC current oscillates. An x-axis 304 is schematically illustrative of time.

The second and third phases for the first electric machine 116 are not shown in FIGS. 3A and 3B, but would be substantially similar to the ideal phase 310 but shifted by, respectively, one hundred twenty and two hundred forty degrees. The ideal phase 310 is shown without its sibling phases to better illustrate the changes in the amplitude and timing that are made to each of the phases of the machine control current to produce the desired effects and heating in the first electric machine 116.

The ideal phase 310 represents a single phase of an ideal control current for the first electric machine 116. While design factors for the first electric machine 116—such as those regarding back EMF and cogging or the sense the position of the rotor—will prevent the first electric machine 116 from reaching a thermodynamically-ideal operating state, the first electric machine 116 may still operate in an ideal state relative to its own design limitations. When operating with an ideal control current, the first electric machine 116 is either motoring or generating at its most-optimal state and is wasting the least amount of energy possible for the first electric machine 116.

When viewed solely for its direct contribution to efficiency of the hybrid powertrain 110—by converting between mechanical and electrical energy—it is always preferable for the first electric machine 116 to be operated with an ideal control current. The first electric machine 116 may also be operated at substantially optimal voltage or power. The control strategy may focus on the voltage or power instead of the current delivered to the first electric machine 116.

However, the techniques and methods disclosed herein include intentionally moving away from the ideal control current and operating the first electric machine 116 at less efficiency than optimal in order to produce heat in the first electric machine 116, the battery 122, or both. This intentionally-created heat may then be used to improve efficiency elsewhere in the hybrid powertrain 110, such as by reducing slip losses in the transmission 114 or by allowing the battery 122 to more-easily charge or discharge.

In FIGS. 3A and 3B, the ideal phase 310 is again shown with markers for its wavelengths. A half-wave mark 312 denotes the return of the ideal phase 310 to zero current after being positive. A full-wave mark 314 denotes the return of the ideal phase 310 to zero current after being negative. Unnumbered quarter-wave marks are shown between the half-wave mark 312 and the full-wave mark 314.

A high-current phase 316 is shown having the same frequency and wavelength as the ideal phase 310. However, as shown in FIG. 3A, the ideal phase 310 has a first amplitude 320 and the high-current phase 316 has an excess amplitude 322. This may be referred to as amplitude-shifting the control current for the first electric machine 116.

If, for example, the engine 112 is producing a fixed amount of torque at a fixed speed of rotation—and, therefore, fixed power—the ideal phase 310 is the current flow which converts that torque and rotation into electrical energy most efficiently. However, when the first PIM 126 commands operation of the first electric machine 116 at the high-current phase 316, more current is drawn through the windings of the stator of the first electric machine 116. As a result, the first electric machine 116 is converting the same torque and power into electrical energy less efficiently.

The excess current of the high-current phase 316 is converted to heat as it circulates through the windings of the first electric machine 116. The excess heat is the result of shifting away from the first amplitude 320 (the ideal current) to the less-efficient excess amplitude 322. Therefore, while the engine 112 is producing the same torque and power input to the transmission 114, less (or possibly none) of that power is being converted to electrical energy for possible storage in the battery 122 and more of that power is being converted to heat.

The resultant heat due to the amplitude shift to the high-current phase 316 warms the first electric machine 116 and, if the first electric machine 116 is disposed within the transmission 114, the excess heat also warms the transmission 114 adjacent to the first electric machine 116. Circulating fluid (or oil) within the housing 118 of the transmission 114 may facilitate heating the transmission 114. The amplitude shift technique may be referred to as energy dissipation in motor (or EDIM), and any machine control current for the first eclectic machine 116 (or the second electric machine 117) using EDIM may be referred to as an energy-dissipating control current.

After the vehicle is started, it may go through a “warm-up” period during which component temperatures are increased from an ambient temperature to a steady state operating temperature. The transmission 114, and the fluid contained therein, is one such component that is heated during the warm-up period. Until the fluid of the transmission 114 is fully heated, its viscosity is increased and the spin losses of rotating components in contact with the fluid are also increased. Reducing spin losses during the warm-up period may improve efficiency and fuel economy of the hybrid powertrain 110.

The wires and cables linking the first electric machine 116, the first PIM 126, and the battery 122 may experience reduced resistance after the transmission 114 has warmed up. Furthermore, the first electric machine 116 may be limited when the hybrid powertrain 110 is very cold, and the ability of the first electric machine 116 to produce large motoring torque or large regenerative torque may be limited until the first electric machine 116 warms up. By driving the first electric machine 116 into inefficient operating ranges by commanded operation at the high-current phase 316, the hybrid powertrain 110 may be able to operate without the use of resistive heaters incorporated into the transmission 114.

The graph 350 of FIG. 3B again shows the ideal phase 310 as the ideal generating control current for the first electric machine 116. An offset phase 352 is shifted behind the ideal phase 310 by a phase offset angle 353. Phase-angle shifting involves internally altering the relative flux between the permanent field (from the rotor in PM rotor motors) and the rotating field (from the stator), to intentionally create inefficiency in operation of the first electric machine 116.

When the first electric machine 116 is controlled with the offset phase 352, the stator flux is moved too far behind the rotor and the first electric machine 116 is unable to generate electrical energy as efficiently as it was at the ideal phase 310. Note that the ideal phase 310 is already causing the stator flux to trail the rotor flux, so that the ideal phase 310 places the first electric machine 116 into generation mode.

This phase-angle shift results in some of the kinetic energy that could have been converted directly into electrical energy being converted into heat in the first electric machine 116. Furthermore, using the phase-angle shift to move the control current to the offset phase 352 decreases the amount of DC current flow to the battery 122 during the regeneration. Therefore, if the battery 122 cannot accept significant current, or has substantial voltage limitations, operating the first electric machine at the offset phase 352 may reduce the amount of current flowing to the battery 122. Like the amplitude shift, the phase-angle shift technique may also be referred to as energy dissipation in motor (EDIM), and any machine control current for the first eclectic machine 116 (or the second electric machine 117) using either of the EDIM techniques may be referred to as energy-dissipating control current. The amount of heat generated by the EDIM techniques may be monitored by the control system 124.

The phase-angle shift that leads to the offset phase 352 may also be implemented by internally offsetting the true north position of the rotor in the control system 124. The true north position of the rotor may be sensed or determined by the control system 124 with, for example and without limitation, a resolver or other position sensor. If the control system 124 treats true north, which should be at twelve-o-clock (or zero degrees), as being offset by the phase offset angle 353, then the flux differential will be greater than optimal.

D-Q transforms may be used to control the first electric machine 116. The D-Q transform is a way of converting the three AC phases of the control current into two DC vectors. D-Q transforms allow the control system 124 to control the magnitude and spatial location (usually the Q vector and the D vector, respectively) of the stator current and flux with respect to the rotor position.

Where D-Q transforms are used to control the first electric machine 116, the true north position of the rotor may coincide with the zero position of the D vector (also referred to as zero I_{d}) when the flux differential is neutral. Therefore, phase-angle shifting the control current for the first electric machine 116 may include moving the D vector past the ideal position for generation. Alternatively, the D-axis could be altered—in a similar way to altering the true north of the rotor—to misalign the relationship between the rotor and the stator flux.

The first electric machine 116 may be controlled with the offset phase 352 in order to intentionally reduce the efficiency relative to the ideal phase 310 in numerous situations. During cold starts of the vehicle, for example, the engine 112 may be requested to run at higher power output than during normal idle conditions in order to increase the heat generated within the engine and for the heater core to warm the cabin. The additional torque and power produced by the engine 112 may then be absorbed by the first electric machine 116 by commanding operation of the first electric machine 116 at the offset phase 352 instead of the ideal phase 310 (which would convert the maximum of the excess engine power to electrical energy). The power absorbed may be viewed as energy dissipated by the first electric machine 116. Furthermore, when the vehicle has excessive inertia—such as during regenerative braking or coasting-down situations where the power output from the hybrid powertrain 110 is negative and trying to decelerate the vehicle—some of the excess power produced by decreasing the inertia of the vehicle may be absorbed by the first electric machine 116 and converted into heat with the offset phase 352.

Additionally, the offset phase 352, and the other EDIM techniques described herein, may be used to protect the powertrain 110 from over-voltage events. For example, rapid changes in vehicle traction or transient events during shifts of the transmission 114 may cause voltage spikes. These spikes may exceed the voltage (or current or power) limitations of the control system 124, the battery 122, the first electric machine 116, or other portions of the powertrain 110. Controlling the first electric machine 116 with the offset phase 352 may allow the voltage spikes to be absorbed by the first electric machine 116 through EDIM, which may protect the remainder of the powertrain 110.

In many situations, only a portion of the excess power produced by the engine 112 or by reducing vehicle inertia may be dissipated by the first electric machine 116 and the remaining portion may be converted to electrical energy for use in the vehicle or storage in the battery 122. Therefore, the whole of the excess power does not have to be dissipated by the first electric machine 116 such that no electrical energy is created or stored, but both heat energy and electrical energy can be created from the excess energy. However, where the battery 122 has a high stator of charge and cannot accept further charge, or where the battery 122 is very cold and has very limited ability to produce or receive current flow, the first electric machine 116 may be used to dissipate substantially all of the excess power as heat and prevent current flow from the first electric machine 116 to the battery 122.

Operating the first electric machine 116 at the offset phase 352 will decrease the current flow to the battery 122, but will also decrease the amount of torque being absorbed (through generation) by the first electric machine 116. An amplified-offset phase 356 may be used to increase the amount of current flowing to the stator in order to increase the generation torque produced by the first electric machine 116. Unlike the offset phase 352, which had the same amplitude as the ideal phase 310, the amplified-offset phase 356 operates at the excess amplitude 322.

If, for example, the engine 112 is running at with an excess torque amount, in order to proved additional heat for the heater core, the first electric machine 116 may be used to absorb that excess torque. Otherwise, the excess torque may be passed through to the final drive 120. However, if the transmission 114 is also very cold, the first electric machine 116 may be called upon to heat the transmission 114.

Operating the first electric machine 116 with the offset phase 352 would cause warming of the transmission 114, but would not absorb the necessary amount of excess torque. Therefore, the control system 124 may increase the current flow to the amplified-offset phase 356. The amplitude increase to the excess amplitude 322 will cause additional torque to be generated by the first electric machine 116, which will absorb the full amount of the excess torque being produced by the engine 112 while maintaining the inefficient phase-offset angle 353. Both the phase-angle shift (from the phase-offset angle 353) and the amplitude shift (from the excess amplitude 322) of the amplified-offset phase 356 will cause system inefficiencies in the first electric machine 116, which will create heat in the first electric machine 116 and the transmission 114.

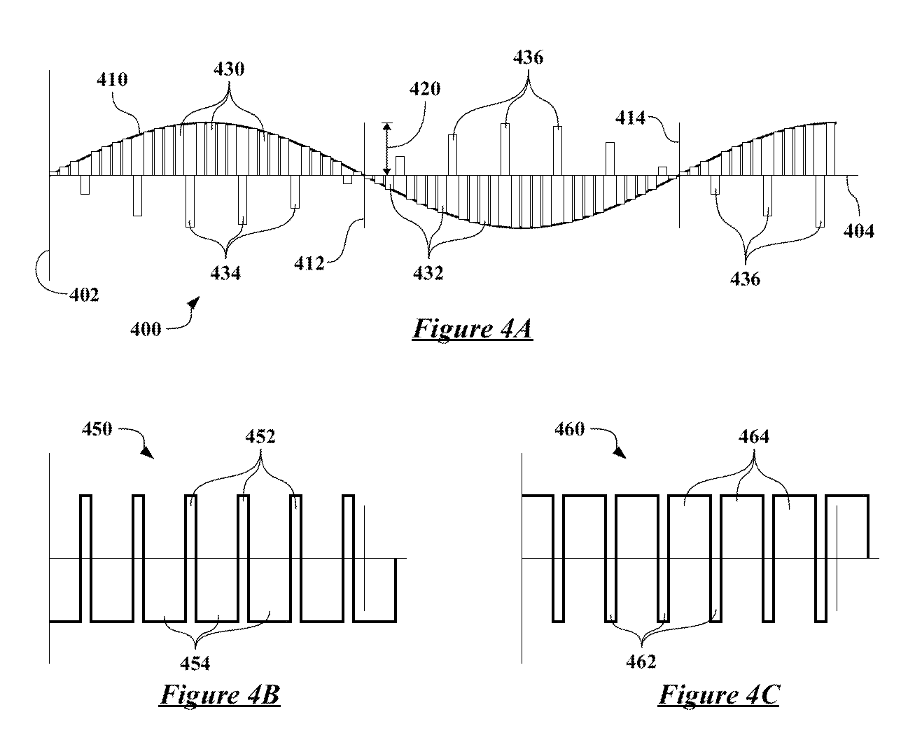

Referring now to FIGS. 4A, 4B, and 4C, and with continued reference to FIGS. 1-3B, there are shown schematic graphical illustrations of machine control currents and the effects thereof on the battery 122 and the DC-bus 130. FIG. 4A is a schematic graph 400 of a single phase of the three-phase control current for the first electric machine 116, showing a pulse-width modulated (PWM) wave forming the AC control current, and configured to heat the battery 122. FIG. 4B is a schematic graph of the resultant effects on the DC-bus 130 and the battery 122 when subjected to a control current similar to that shown in FIG. 4A during a discharge event. FIG. 4C is a schematic graph of the resultant effects on the DC-bus 130 and the battery 122 during a charge event.

The graph 400 shown in FIG. 4A again shows a first phase 410 operating at an ideal generation state, in which the first electric machine 116 may be converting kinetic energy into electric energy at peak efficiency for a given set of operating conditions. The first phase 410 is shown schematically along with the PWM pulses used to form or emulate the AC current. Therefore, the first phase 410 is actually a series of varying DC pulses which combine to create an AC current shape or waveform.

A y-axis 402 is schematically illustrative of current (or voltage) and moves from positive to negative as the AC current oscillates. An x-axis 404 is schematically illustrative of time. The second and third phases for the first electric machine 116 are not shown in FIG. 4A, but may be substantially similar to the first phase 410 but shifted by, respectively, one hundred twenty and two hundred forty degrees. Generally, changes to the control current for the first machine 116 are identical in each of the three phases.

The first phase 410 is again shown with markers for its wavelengths. A half-wave mark 412 denotes the return of the first phase 410 to zero current after being positive. A full-wave mark 414 denotes the return of the first phase 410 to zero current after being negative. Unnumbered quarter-wave marks are shown between the half-wave mark 412 and the full-wave mark 414. The first phase 410 has a first amplitude 420.

The first phase 410 is formed by commanding PWM pulses to form a wave to emulate the first phase 410. The PWM wave includes a plurality of pulses 430 in a first direction (upward, as viewed in FIG. 4A) during the first half of the PWM wave, which is from the start to the half-wave mark 412. The PWM wave further includes a plurality of pulses 432 in a second direction (downward, as viewed in FIG. 4A) during the second half of the PWM wave, which is from the half-wave mark 412 to the full-wave mark 414. If only the normal pulses 430 and 432 were used, the first phase 410 would be completely emulated and the first electric machine 116 would be generating electrical energy at or near the maximum efficiency.

As shown in FIG. 4A, the first PIM 126 is also commanding a plurality of first counter pulses 434. The first counter pulses 434 are in the second direction during the first half of the PWM wave. Therefore, the first counter pulses 434 are individual pulses in the opposite direction from the pulses 430. Similarly, the first PIM 126 is commanding a plurality of second counter pulses 436, which are in the first direction during the second half of the PWM wave.

When the first phase 410 of is emulated with only the normal pulses 430 and 432, the battery 122 is either charging or discharging with a consistent DC flow into or out of the battery 122. However, the first counter pulses 434 and the second counter pulses 436 cause the DC current at the DC-bus 130 to oscillate during the first counter pulses 434 and the second counter pulses 436. This oscillation quickly changes the state of ion flow inside of the battery 122, and may result in heating of the battery 122. This heating may allow the battery 122 to be heated to a more-efficient operating temperature without resistive heaters and without either charging or draining the battery 122 (i.e. the oscillation may be charge-neutral to the battery 122).

As shown in FIGS. 4B and 4C, the direction of current flow (and voltage differential) on the DC-bus 130 momentarily changes as a result of the first counter pulses 434 and the second counter pulses 436. As a result, current direction between the battery 122 and the first PIM 126 also momentarily changes. In the illustrative example shown in FIG. 4A, every fifth PWM pulse switches from the normal pulses 430 or 432 to either the first counter pulses 434 or the second counter pulses 436. Therefore, regardless of whether the battery 122 is generally in a discharge event (as shown in FIG. 4B) or a charge event (as shown in FIG. 4C), short bursts of current flow in the opposite direction.

In FIGS. 4B and 4C, the y-axis 402 is schematically illustrative of DC current flow (or voltage) to the battery 122. An x-axis 404 is schematically illustrative of time. Current flow into the battery 122 is shown as positive (up in FIGS. 4B and 4C) and represents charging of the battery 122. Current flow out of the battery 122 is shown as negative (downward in FIGS. 4B and 4C) and represents discharging of the battery 122.

FIG. 4B is a schematic graph 450 of the resultant effects on the DC-bus 130 and the battery 122, when subjected to a control current similar to that shown in FIG. 4A. FIG. 4B shows rapid charge pulses 452 interspersed with discharge pulses 454 of the discharge event. The frequency of the rapid charge pulses 452 relative to the discharge pulses 454 is the same as the relative frequency of first and second counter pulses 434 and 436 to the normal pulses 430 and 432; such that the rapid charge pulses 452 cause the battery 122 to charge for approximately one-fifth of the total time during the discharge event shown in FIG. 4B.

Similarly, FIG. 4C is a schematic graph 460 the resultant effects on the DC-bus 130 and the battery 122 to those shown in FIG. 4B. However, FIG. 4C shows rapid discharge pulses 462 interspersed with charge pulses 464 of the charge event. FIGS. 4B and 4C and intended to be generally to the same time scale as FIG. 4A.

Note that while FIGS. 4B and 4C show a time lapse of only about one half of a wave length of the first phase 410 shown in FIG. 4A, the remainder of the wave is substantially identical when viewed at the DC-bus 130. Therefore the DC current flowing to and from the battery 122 does not flip as the first phase 410 crosses the zero line. The changes in current flow direction are due to the first and second counter pulses 434 and 436 causing the rapid charge pulses 452 in FIG. 4B or the rapid discharge pulses 462 shown in FIG. 4C. Note also that FIGS. 4B and 4C represent the combined effects on the DC-buss 130 of each of the three phases of the control current (one of which is the first phase 410 shown in FIG. 4A) for the first electric machine 116.

The overall frequency of the first and second counter pulses 434 and 436—and the corresponding counter pulses in the other two phases—is configured to heat the battery 122 by rapidly reversing ion flow within the battery 122. Depending upon the number of PWM pulses per second used to control the first electric machine 116, and upon the relative frequency of the first and second counter pulses 434 and 436, the frequency of the DC oscillations (either the rapid charge pulses 452 in FIG. 4B or the rapid discharge pulses 462 shown in FIG. 4C) may very greatly.

The magnitude, frequency, and pulse width of the first and second counter pulses 434 and 436 are calibrateable such that the battery 122 temperature is raised without disturbing the chemical composition of the battery 122. The specific magnitude, frequency, and pulse width will depend upon the temperature of the current battery 122 and its voltage limits at that temperature. Frequencies of the DC oscillations (either the rapid charge pulses 452 in FIG. 4B or the rapid discharge pulses 462) may be on the order of ten to twenty kilohertz in order to heat the battery 122 without caused any irreversible chemical changes.

Increasing the temperature of the battery 122 may allow the battery 122, and the hybrid powertrain 110, to operate more efficiently by allowing more flexibility of hybrid operations. For example, increasing the temperature of the battery 122 may allow additional regenerative braking by the first electric machine 116, as compared to lower temperatures in the battery 122, which may limit the rate of current flow to or from the battery 122.

FIGS. 4B and 4C show the first and second counter pulses 434 and 436 causing rapid charge pulses 452 in a discharge event and rapid discharge pulses 462 in charge event, respectively. However, the first and second counter pulses 434 and 436 may be interspersed more frequently or with greater pulse width, such that the net current flow through the DC-bus 130 is zero (charge-neutral) and the battery 122 is neither charging nor discharging over time.

Interspersing rapid charge pulses 452 in a discharge event, as shown in FIG. 4B, may further be used to protect the battery 122 from under-voltage conditions by increasing the effective DC voltage on the battery 122. Similarly, interspersing rapid discharge pulses 462 in a charge event, as shown in FIG. 4C, may further be used to protect the battery 122 from over-voltage conditions by decreasing the effective DC voltage on the battery 122.

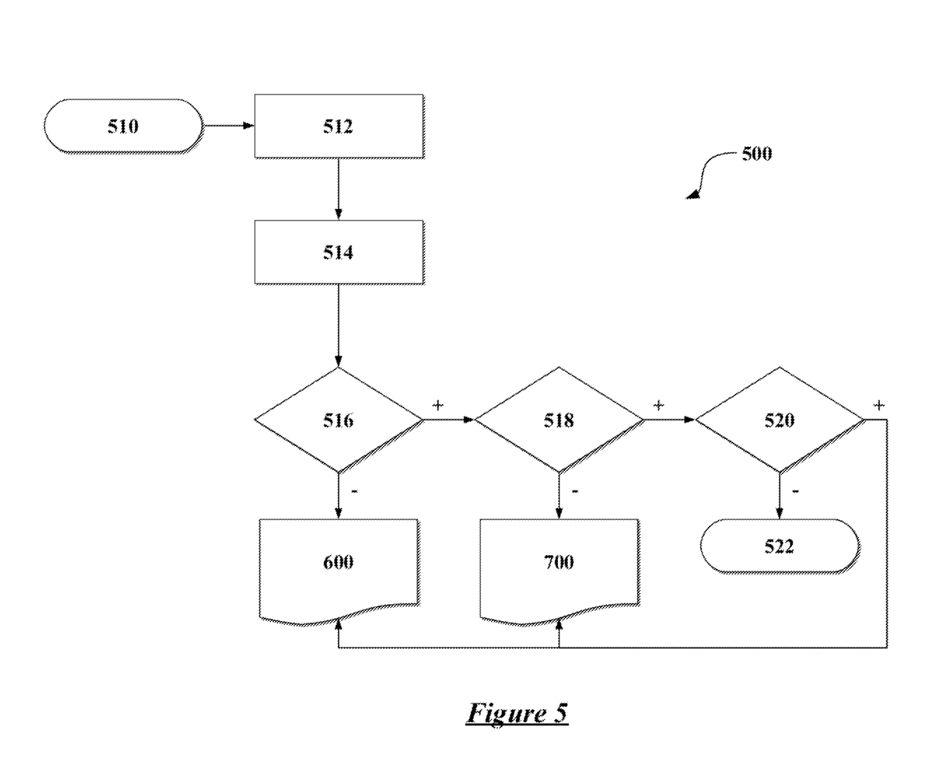

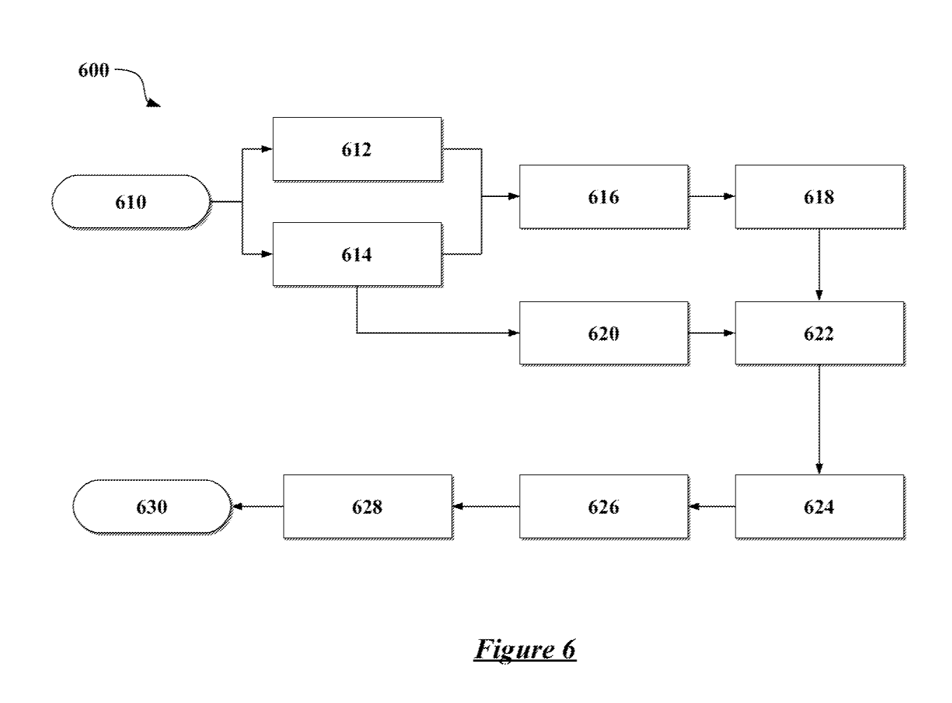

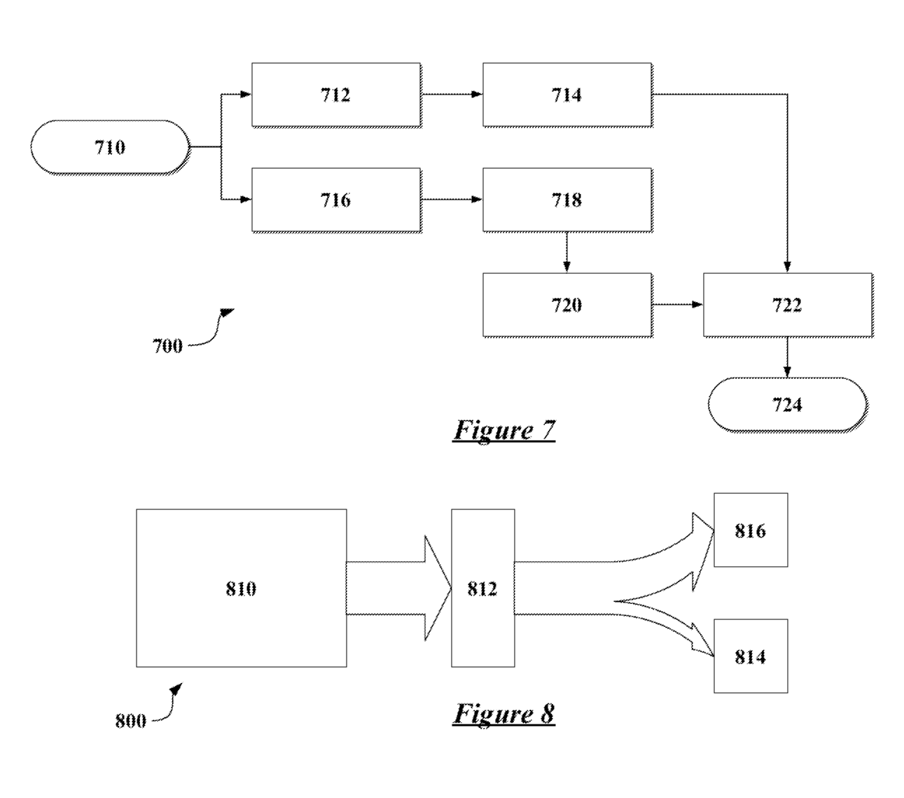

Referring now to FIG. 5, FIG. 6, and FIG. 7, there are shown schematic flow chart diagrams of an algorithm or method 500 for controlling a hybrid powertrain, such as the hybrid powertrain 110 shown in FIG. 1. The exact order of the steps of the algorithm or method 500 shown in FIGS. 5-7 is not required. Steps may be reordered, steps may be omitted, and additional steps may be included. Furthermore, the method 500 may be a portion or sub-routine of another algorithm or method.

FIG. 5 shows a high-level diagram of the method 500. FIG. 6 shows a sub-routine 600 of the method 500, which is configured to heat the first electric machine 116 and the transmission 114. FIG. 7 shows another sub-routine 700 of the method 500, which is configured to heat the battery 122.

For illustrative purposes, the method 500 may be described with reference to the elements and components shown and described in relation to FIG. 1 and may be executed by the control system 124. However, other components may be used to practice the method 500 and the invention defined in the appended claims. Any of the steps may be executed by multiple components within the control system 124.

Step 510: Start.

The method 500 may begin at a start or initialization step, during which time the method 500 is monitoring operating conditions of the vehicle and of the hybrid powertrain 110. Initiation may occur in response to the vehicle operator inserting the ignition key or in response to specific conditions being met, such as in response to a negative torque or power request (braking or deceleration request) from the driver or cruise control module combined with a predicted or commanded downshift. Alternatively, the method 500 may be running constantly or looping constantly whenever the vehicle is in use.

Step 512: Determine Electric Machine Temperature.

The control system 124 will test, sense, or otherwise determine the temperature of the first electric machine 116. Alternatively, the control system 124 may determine the temperature of the first electric machine 116 indirectly by determining the ambient temperature and whether the vehicle has been at rest long enough for the first electric machine 116 to have equalized with the ambient temperature.

Step 514: Determine Battery Temperature.

The control system 124 will also test, sense, or otherwise determine the temperature of the battery 122. Alternatively, the control system 124 may determine the temperature of the battery 122 indirectly by determining the ambient temperature and whether the vehicle has been at rest long enough for the battery 122 to have equalized with the ambient temperature. The control system 124 may also be monitoring the ambient temperature. Even thought the components themselves may be very cold, the ambient temperature may be able rectify the situation without the heating methods described herein.

Step 516: Heat Electric Machine Only?

Based upon the temperatures of the battery 122 and the first electric machine 116, the control system 124 will determine whether either the battery 122, the first electric machine 116, or both, needs to be heated. At decision step 516, the control system 124 determines whether only the first electric machine 116 needs to be heated. If only the first electric machine 116 needs to be heated, the method 500 will proceed to a phase-shift sub-routine 600, which heats the first electric machine 116.

As viewed in FIG. 5, basic decision steps answered positively (as a yes) follow the path labeled with a “+” sign (the mathematical plus or addition operator). Similarly, decision steps answered negatively (as a no) follow the path labeled with a “−” sign (the mathematical minus or subtraction operator).

Step 518: Heat Battery Only?

If the control system determines that the conditions are not conducive to only heating the first electric machine 116, the control system 124 determines whether only the battery 122 needs to be heated. If only the battery 122 needs to be heated, the method 500 will proceed to a shape-shift sub-routine 700, which heats the battery 122.

Step 520: Heat Both Battery and Electric Machine?

If the control system determines that the conditions are not conducive to only heating the battery 122, the control system 124 determines whether both the battery 122 and the first electric machine 116 need to be heated. If both the battery 122 and the first electric machine 116 need to be heated, the method 500 will proceed to both the phase-shift sub-routine 600 and the shape-shift sub-routine 700.

Step 522: End.

However, if neither the battery 122 nor the first electric machine 116 need to be heated, the method 500 will proceed to an end step. The end step may actually be a return to start, or the method 500 may wait until again called upon.

Sub-Routine 600: Phase Shift to Heat Electric Machine.

Step 610: Start.

The phase-shift sub-routine 600 starts whenever commanded by the method 500 and the control system 124. The phase-shift sub-routine 600 and the shape-shift sub-routine 700 may be executed simultaneously or independently.

Step 612: Determine Power Request.

Separate from the determination of whether the battery 122 and the first electric machine 116 need to be heated, the hybrid powertrain 110 may have a power request based upon needs to provide fraction for or otherwise operate the vehicle. In extreme-cold situations this power request may be handled completely by the engine 112, because the first electric machine 116 may be limited in its ability to provide either positive or negative torque due to the temperature of the battery 122, the first electric machine 116 or both. For example, the rotor of the electric machine 116 may be moving as the engine 112 propels the vehicle or as the engine 112 itself tries to warm up.

The power request may include the request for the engine 112 and for the final drive 120. If the vehicle is moving, the request for the final drive 120 may be positive or negative (motoring or generating). Alternatively, if the vehicle is stationary (such as during cold-start warm-up) the request for the final drive 120 may be substantially zero. The power request may also include needs for operating vehicle accessories, such as, without limitation: lights, entertainment and navigation systems, accessories, and other electrical needs of the vehicle. Although these additional needs may not come directly from the hybrid powertrain 110, it is the hybrid powertrain 110 (including the battery 122) that supplies the electrical power for the vehicle.

Step 614: Determine Heat Power and Excess Power.

In order to heat the first electric machine 116, the hybrid powertrain 110 will need some excess power, which can be inefficiently-absorbed in generating mode or inefficiently-produced in motoring mode. Heating the first electric machine 116 through inefficient generating is described herein. However, motoring modes may also be used with the techniques described herein.

If the vehicle is moving, the excess power may come from regenerative braking. However, if the vehicle is not moving, the excess power may be supplied by the engine 112, and may be referred to as a heat power, which is produced by commanding the engine 112 to produce torque in addition to the torque request for the hybrid powertrain 110. The heat power produced by the engine 112 may also be used to warm a heater core (not shown) and warm the passenger cabin of the vehicle. For example, the engine 112 may be commanded to run at higher speeds and burn additional fuel when the vehicle is started in very cold ambient temperatures.

Whether the excess power is supplied from the engine 112 or from regenerative braking of the vehicle, much of the commanded heat power will be absorbed by generation from the first electric machine 116. If the engine 112 is producing the (excess) heat power, the engine 112 will operate at a total power, which is the sum of the requested power plus the heat power. A portion of the heat power absorbed by the first electric machine 116 may be converted into heat and a portion may be converted into electrical energy for storage in the battery 122.

The control system 124 will have requested some amount of power (which may be zero) from the first electric machine 116 in order to satisfy the driving demands on the hybrid powertrain 110. For purposes of illustration, this description will assume that the hybrid powertrain 110 does not require any power capture or regeneration from the first electric machine 116 to propel the vehicle. Therefore, the generation power of the first electric machine 116 is substantially equal to the heat power produced by the engine 112.

Step 616: Determine Ideal Flux.

From the heat power request for heating the first electric machine 116, the control system 124 may determine an ideal flux. The ideal flux is the flux magnitude and position (relative to the rotor) that would most-efficiently generate electrical energy from the heat power in the hybrid powertrain 110. However, because the control system 124 is trying to create heat in the first electric machine 116, the control system 124 will not command operation at the ideal flux.

The control system 124 may also determine a net-zero flux, which results in substantially zero torque or power output from the first electric machine 116, such that it is neither motoring nor generating when operating at the net-zero flux. The net-zero flux would allow the rotor of the electric machine 116 to freely spin without a flux differential either pushing (motoring) or pulling (generating) relative to the stator. However, the net-zero flux generally does not result in heating of the first electric machine 116.

Step 618: Determine Ideal Current.

The control system 124 would create the ideal flux by determining an ideal current flow from the ideal flux. The ideal current flow would convert the excess heat power into electrical energy at substantially maximum efficiency. The ideal flux is achieved by a phase angle offset from the net-zero flux (the neutral state of the first electric machine 116). However, if the first electric machine 116 is operated with the ideal current flow, all of the electrical energy generated by the first electric machine 116 will need to stored in the battery 122 and the first electric machine 116 will not be heated.

Step 620: Determine Motor Heat.

From the heat power, the control system 124 determines the amount or proportion of power being generated by the first electric machine 116. As stated above, this illustrative example assumes that all of the excess power in the hybrid powertrain 110 will be converted into heat by the electric machine 116 (and none will be converted into electrical energy for storage in the battery 122). However, if the control system 124 was converting only a portion of the excess power into heat—for example, during significant regenerative braking, where power is available for both storage and heating—the control system would command only a portion of the excess power as heat power to the first electric machine 116.

Step 622: Determine Battery Limits.

The control system 124 will check to determine whether the battery 122 can accept or provide any current or voltage. This check determines whether the battery 122 can participate in dissipating the excess power. However, when all of the excess power will be converted to heat power through inefficient-operation of the first electric machine 116, little or no current flow will take place between the battery 122 and the first electric machine 116. If charging of the battery 122 were planned, and the battery 122 could not accept the charge, the control system 124 may have to alter the command signals for the first electric machine 116 to convert more (or all) of the excess power to heat power.

Step 624: Determine Phase-Angle Shift.

The control system 124 will determine or calculate a phase-angle shift, which will reduce the efficiency of conversion of kinetic energy from the rotor into electrical energy with the first electric machine 116. The remaining kinetic energy will be converted into heat within the first electric machine 116, heating both the first electric machine 116 and the transmission 114. An example of phase-angle shift is shown as the offset phase 352 in FIG. 3B.

Step 626: Determine Amplitude Shift.

The control system 124 may also seek to use an amplitude shift to either further produce heat in the first electric machine 116 or to increase the torque absorbed by the phase-angle shift determined in step 624. An example of purely amplitude shift is shown as the high-current phase 316 in FIG. 3A.

The amplitude shift causes excess current flow through the stator windings and the first electric machine 116 heats due to the excess current flow. The control system 124 communicates the excess current flow to the first PIM 126 and operating at the excess current flow includes commanding the excess current flow as part of the machine control current supplied by the first PIM 126.

Step 628: Combined Control Current.

The excess current flow may have substantially the same phase angle as the ideal current flow, but have amplitude greater than the ideal current flow. Alternatively, if there was also a phase-angle shift, the excess current flow will increase the amplitude of the phase-angle shifted machine control current but maintain its phase angle. The control system 124 will command the first electric machine 116 to operate at the machine control current which includes the combined effects of phase-angle shift and the amplitude shift.

The control system 124 may implement the amplitude shift in order to increase the amount of torque (and, therefore, power) absorbed by the first electric machine 116 when the control system 124 has also implemented a phase-angle shift. The inefficiencies created by the phase-angle shift may reduce the amount of power absorb by the electric machine 116. Therefore, in order to absorb the full amount of heat power produced by the engine 112 and balance power output of the hybrid powertrain 110, the control system may increase the mount of power absorbed during the phase-angle shift by also using the amplitude shift.

Step 630. Heat Electric Machine, End.

Operating the first electric machine 116 at combined machine control current creates waste heat in the stator windings of the first electric machine 116. The waste heat may be transferred into the fluid of the transmission 114 to heat both the first electric machine 116 and the other components of the transmission 114. Ending the method 300 may include running at the combined machine control current for a predetermined period or until a predetermined temperature of the first electric machine 116 or the transmission 114 is reached. The phase-shift sub-routine 600 may be iterating or looping until conditions change or may lay dormant until again called upon.

Sub-Routine 700: Shape Shift to Heat Electric Machine.

Step 710: Start.

The shape-shift sub-routine 700 starts whenever commanded by the method 500 and the control system 124. The shape-shift sub-routine 700 and the phase-shift sub-routine 600 may be executed simultaneously or independently.

Step 712: Determine Base Current.

The control system 124 determines the base current being commanded with the first PIM 126 for operating the first electric machine 116. Generally, the command current will be an AC current communicated between the first PIM 126 and the first electric machine 116. The base current may occur during the phase-shift sub-routine 600 or during other operations of the first electric machine 116.

Step 714: Determine Base PWM Wave.

The control system 124 determines a base PWM wave to emulate the base current flow, wherein the base PWM wave includes a plurality of pulses in the first direction during the first half of the PWM wave and a plurality of pulses in the second direction during the second half of the PWM wave. The normal pulses 430 and 432 in FIG. 4 are illustrative of the base PWM wave.

Step 716: Determine Temperature Change.

Depending upon the amount of temperature change needed for the battery 122, the control system 124 may use more or less-aggressive frequencies—such as those created by the counter pulses—to heat the battery 122. The voltage across the battery 122 and the amplitude of DC current flowing to or from the battery 122 will also affect the rate of temperature change experienced by the battery 122. Furthermore, when the battery 122 is very cold, the control system 124 may begin by slowly heating the battery 122 and then increasing the heating rate.

Step 718: Determine DC-Bus Oscillation Frequency.

From the temperature change, the control system 124 determines the DC oscillations that will be commanded by the first PIM 126 and communicated to the battery 122. These oscillations will be sent through the DC-bus 130 and cause changes in the ionic flow direction within the battery 122. Two examples of such oscillations are shown in FIGS. 4B and 4C. The magnitude of the pulses sent through the DC-bus 130 will also be determined based upon the temperature and operating conditions of the battery 122. The shape of the oscillations communicated through the DC-bus 130 shown in FIGS. 4B and 4C are square waves. However, triangular waves or sine waves—in addition to other wave forms suitable for causing oscillations at controlled frequency—may be used.

Step 720: Determine PWM Ripple Frequency.

From the DC-bus oscillation frequency, the control system 124 determines the PWM ripple frequency that will be commanded by the first PIM 126 for operation of the first electric machine 116. This includes (as shown in FIG. 4) determining or scheduling the first counter pulses 434, which are in the second direction during the first half of the PWM wave, and determining or scheduling the second counter pulses 436, which are in the first direction during the second half of the PWM wave.

Step 722: Combined PWM Wave.

The control system 124 combines the base PWM wave and the ripple frequency and commands the first PIM 126 to operate the first electric machine 116 with the combined PWM wave. This includes commanding the first counter pulses 434 and commanding the second counter pulses 436. One such combined PWM wave is illustrated in the graph 400 of FIG. 4.

By operating the first electric machine 116 and the first PIM 126 at the combined PWM wave results in generating an alternating or oscillating DC current from the excess current flow if the control system 124 is also heating the first electric machine 116. This alternating or oscillating DC current is fed or communicated to the battery 122, and internally heats the battery 122.

Step 724. Heat Battery, End.

Operating the first electric machine 116 and the first PIM 126 with the counter pulse—which may be occur concurrently with the excess current flow—creates heat in the battery 122. The end step may include running with the counter pulse for a predetermined period or until a predetermined temperature of the battery 122 is reached. The shape-shift sub-routine 700 may be iterating or looping until conditions change or may lay dormant until again called upon.

Referring now to FIG. 8, and with continued reference to FIGS. 1-7, there is shown a schematic power-flow diagram 800 of the intentional conversion of the excess power into multiple energy forms by the first electric machine 116 of the hybrid powertrain 110 shown in FIG. 1. The power-flow diagram 800 shows the controlled conversion of an input power 810 into multiple power or energy outputs.

The hybrid powertrain 110 normally of operates based upon the requested power, which substantially meets the needs of the hybrid powertrain. These needs include traction for the vehicle—both propulsion and deceleration—and the electrical needs of the vehicle. The excess power is a non-zero power that is not included in the requested power. The input power 810 may be the excess power of the hybrid powertrain 110.

The power-flow diagram 800 shows an energy dissipation in motor (EDIM) conversion 812, which converts the excess power into some other form of power. The EDIM conversion 812 may be implemented by the first electric machine 116, the second electric machine 117, or both, and through control by components including the first PIM 126, the second PIM 127, and the control system 124. However, the EDIM conversion 812 will be described herein with reference to only the first electric machine 116.

The EDIM conversion 812 selectively distributes power between an optimal power path 814 and a heat power path 816, although other power paths may be present. The optimal power path 814 represents control of the first electric machine 116 with the ideal control current, such that the first electric machine 116 is either motoring or generating at its most-optimal state. When the EDIM conversion 812 is sending all power to the optimal power path 814, the first electric machine 116 is converting the available mechanical energy to the greatest possible amount of electrical energy while in generating mode, or is converting the available electrical energy to the greatest possible amount of mechanical energy while in motoring mode, because the ideal control current absorbs the excess power with the first electric machine 116 at substantially optimal efficiency.

The excess power providing the input power 810 and being converted by the EDIM conversion 812 may come from different sources and in different situations. For example, while the vehicle has excess inertia, such as during coasting or deceleration, the first electric machine 116 may be placed into generation mode to decelerate the vehicle through regenerative braking. If all of the mechanical energy removed by regenerative braking were converted to electrical energy and stored in the battery 122, the EDIM conversion 812 would be sending power to the optimal power path 814 only. However, the battery 122 may be limited in the amount of power it can receive, in order to protect from over-charging or because the battery 122 is very cold.

If some of the mechanical energy removed from regenerative braking is converted to heat energy and dissipated into the transmission 114, the EDIM conversion 812 is sending that power to the heat power path 816 instead of the optimal power path 814. In FIG. 8, the EDIM conversion 812 is absorbing the excess power with the first electric machine 116 by sending a large portion of the excess power to the heat power path 816 and the remainder to the optimal power path 814. When operating as shown in FIG. 8, the control system 124 is sending the energy-dissipating control current to the first electric machine 116, which causes the first electric machine 116 to convert a portion of the excess power into heat energy.

The excess power providing the input power 810 may also come from heat power provided by the engine 112 during cold starts and cold operation. In those situations, the heat power is excess mechanical power form the engine 112 in addition to the fraction needs of the hybrid powertrain 110. The heat power from the engine 112 may create internal heat to warm the engine 112 itself, create heat for use in the vehicle cabin through the heater core, and still provide excess power to the EDIM conversion 812. The excess power may then be converted by generation with the first electric machine 116 partially into, as shown, heat energy at the heat power path 816 and partially into electrical energy which is stored in the battery 122 in the optimal power path 816.

The power-flow diagram 800 also applies while the first electric machine 116 is in motoring mode and is providing positive mechanical power to the hybrid powertrain 110. Therefore, the excess power providing the input power 810 may also come from additional electrical power provided from the battery 122 which is not needed for traction of the vehicle. In such situations the optimal power path 814 represents conversion of the electrical power from the battery 122 into mechanical power which is transferred to the final drive 120. The EDIM conversion 812 may also send some of the excess power to the heat power path 816, such that the first electric machine 116 is operated with the energy-dissipating current and some of the excess power is converted into heat power and dissipated into the first electric machine 116 and the transmission 114.

The detailed description and the drawings or figures are supportive and descriptive of the invention, but the scope of the invention is defined solely by the claims. While the best mode, if known, and other embodiments for carrying out the claimed invention have been described in detail, various alternative designs and embodiments exist for practicing the invention defined in the appended claims.

1. A method of controlling a hybrid powertrain having an electric machine and an engine, the method comprising:
determining a requested power for the hybrid powertrain; wherein the requested power substantially meets the needs of the hybrid powertrain;
determining an excess power for the hybrid powertrain, wherein the excess power is non-zero and is not included in the determined requested power;
absorbing the excess power with the electric machine;
determining an ideal control current for the electric machine, wherein the ideal control current absorbs the excess power with the electric machine at substantially optimal efficiency;
determining an energy-dissipating control current for the electric machine, wherein the energy-dissipating control current causes the electric machine to convert a portion of the excess power into heat energy; and
controlling the electric machine with the energy-dissipating control current, such that the electric machine produces heat energy.

2. The method of claim 1, wherein absorbing the excess power with the electric machine includes operating the electric machine in generating mode, and wherein the generating mode removes power from the hybrid powertrain.

3. The method of claim 2, wherein the energy-dissipating control current causes the electric machine to convert substantially all of the excess power into heat energy.

4. The method of claim 3, wherein the energy-dissipating control current is achieved by phase-angle shifting relative to the ideal control current.

5. The method of claim 3, wherein the energy-dissipating control current is achieved by increasing the amplitude relative to the ideal control current, and wherein the energy-dissipating control current has substantially the same phase angle as the ideal control current.

6. The method of claim 3, wherein the energy-dissipating control current is achieved by phase-angle shifting relative from the ideal control current, and wherein the energy-dissipating control current is achieved by increasing the amplitude relative to the ideal control current.

7. The method of claim 6, wherein the electric machine is in electrical communication with a power inverter module, and wherein operating at the energy-dissipating control current includes commanding the energy-dissipating control current with the power inverter module.

8. The method of claim 7, further comprising:
commanding a PWM wave to emulate the energy-dissipating control current, wherein the PWM wave includes a plurality of direct current pulses in a first direction during a first half of the PWM wave and a plurality of direct current pulses in a second direction during a second half of the PWM wave.

9. The method of claim 8, further comprising:
commanding the engine to operate at a total power, which is the sum of the requested power plus a heat power, and
wherein the excess power for the hybrid powertrain is substantially equal to the heat power of the engine.

10. The method of claim 3, wherein the hybrid powertrain is incorporated into a vehicle, and wherein the requested power is negative such that the hybrid powertrain is removing inertia of the vehicle.

11. The method of claim 10, wherein the machine is in electrical communication with a power inverter module and the power inverter module is in communication with a battery, and further comprising:
determining whether the battery is capable of accepting electrical power; and
commanding the energy-dissipating control current with the power inverter module such that substantially no electrical power flows to the battery.

12. The method of claim 11, wherein the energy-dissipating control current is achieved by phase-angle shifting relative to the ideal control current.

13. The method of claim 11, wherein the energy-dissipating control current is achieved by increasing the amplitude relative to the ideal control current, and wherein the energy-dissipating control current has substantially the same phase angle as the ideal control current.

14. A method of controlling a hybrid powertrain having an electric machine within a transmission and an engine, the method comprising:
determining a requested power for the hybrid powertrain; wherein the requested power substantially meets the needs of the hybrid powertrain;
determining an excess power for the hybrid powertrain, wherein the excess power is non-zero and is not included in the determined requested power;
absorbing the excess power with the electric machine such that the electric machine produces heat energy; and
warming the transmission with the heat energy produced by the electric machine.

15. The method of claim 14, wherein the hybrid powertrain is incorporated into a vehicle, and:
wherein the requested power is negative such that the hybrid powertrain is removing inertia of the vehicle, and
wherein the excess power is derived from inertia of the vehicle.

16. The method of claim 15, further comprising:
determining an ideal control current for the electric machine, wherein the ideal control current absorbs the excess power with the electric machine at substantially optimal efficiency;
determining an energy-dissipating control current for the electric machine, wherein the energy-dissipating control current causes the electric machine to convert a portion of the excess power into heat energy; and
controlling the electric machine with the energy-dissipating control current, such that the electric machine produces heat energy.

17. The method of claim 16, wherein absorbing the excess power with the electric machine includes operating the electric machine in generating mode, and wherein the generating mode removes power from the hybrid powertrain.

18. The method of claim 17, wherein the electric machine is in electrical communication with a power inverter module, and wherein operating at the energy-dissipating control current includes commanding the energy-dissipating control current with the power inverter module.

19. The method of claim 18, wherein the energy-dissipating control current is achieved by phase-angle shifting relative to the ideal control current.

20. The method of claim 19, wherein the energy-dissipating control current causes the electric machine to convert substantially all of the excess power into heat energy.
